(19) United States
(12) Patent Application Publication
(10) Pub. No.: US 2026/0067642 A1
(43) Pub. Date: Mar. 5, 2026

(54) Method for Providing Location-Dependent Traffic Information

(71) Applicant: Robert Bosch GmbH, Stuttgart (DE)

(72) Inventors: Benjamin Schoen, Ushikubo Tsuzuki-Ku (JP); Andreas Wienss, Eningen Unter Achalm (DE)

(21) Appl. No.: 19/105,810

(22) PCT Filed: Jun. 29, 2023
(86) PCT No.: PCT/EP2023/067772

§ 371 Date: Feb. 23, 2025

(30) Foreign Application Priority Data
Aug. 26, 2022 (DE) 10 2022 208 867.0

(51) Int. Cl. H04W 4/029; G08G 1/005; G08G 1/16; H04W 4/02

(52) U.S. Cl. CPC H04W 4/029; H04W 4/027; G08G 1/005; G08G 1/16

(57) ABSTRACT

A method for providing location-dependent traffic information includes (i) defining a monitoring area for a first mobile device, (ii) capturing an associated current location of the first mobile device, (iii) transmitting, by the first mobile device, location data or movement information to a server in response to the current location being present within the monitoring area, (iv) performing a checking operation by the server, wherein the first mobile device is checked as to whether a condition is met, wherein the predefined condition defines a dependence between the current location data or movement information of the first mobile device and current location data or movement information of a second mobile device also within the monitoring area, and wherein the predefined condition indicates the presence of a traffic situation caused by the second mobile device, and (v) transmitting, by the server, information to the first mobile device in response to the checking operation determining that the predefined condition is met, wherein the information indicates the presence of the particular traffic situation with respect to the second

### PRIOR ART

Various systems have the goal of providing a virtual shield for vulnerable road users (VRUs) based on mobile communications. Location data is typically transmitted to servers over a large area. However, this is unfavorable in terms of both the volume of data generated and the server capacity required for the same. The data generated must thus be processed, even if the present traffic situation is usually entirely non-critical.

### DISCLOSURE OF THE INVENTION

The method according to the invention for providing location-dependent traffic information comprises defining a monitoring area for a first mobile device, capturing an associated current location of the first mobile device, transmitting location data or movement information to a server by the first mobile device in response to the current location being within the monitoring area, performing a checking operation by the server, in that a check is made as to whether a predefined condition is met, in that the predefined condition defines a dependence between the current location data or movement information of the first mobile device and current location data or movement information of a second device also present within the monitoring area, the predefined condition indicating the presence of a traffic situation caused by the second device, and transmitting information to the first mobile device by the server in response to the checking operation determining that the predefined condition is met, the information comprising the presence of the particular traffic situation with respect to the second device.

A mobile device according to the invention for providing location-dependent traffic information is configured to capture a definition of a monitoring area, to capture a current location of the mobile device, to transmit current location data of the mobile device to a server in response to the current location of the mobile device being within the monitoring area, and to receive information from the server, wherein the information indicates the presence of a particular traffic situation with respect to a second device and potentially further information.

A server according to the invention for providing location-dependent traffic information is configured to receive current location data or movement information from mobile devices present within a monitoring area according to the current location thereof, to perform a checking operation, in that a check is made for at least a first device of the mobile devices present within the monitoring area as to whether a predefined condition is met, in that the predefined condition defines a dependence between the current location data or movement information of the first mobile device and current location data or movement information of a second device also present within the monitoring area, wherein the predefined condition indicates a presence of a traffic situation caused by the second mobile device, and to transmit information to the first and/or the second mobile device in response to the checking operation determining that the condition is met, wherein the information indicates the presence of the particular traffic situation with respect to the respective other device, potentially in combination with further conditions.

The server according to the invention and at least one mobile device according to the invention combine to form a system according to the invention for providing location-dependent traffic information. Said system is configured to perform a method according to the invention. It is noted, however, that the method performed exclusively by the server or exclusively by one of the mobile devices is also advantageous in itself.

Preferably, the predefined condition defines a dependence between the current location data or movement information of the first mobile device and current location data or movement information of a second device also present within the monitoring area, and further information from external sources (e.g. presence of obstructions to visibility at this point, poor viewing conditions (night, fog), traffic density, sun position (blinding), etc.).

Preferably, information is also transmitted by the server to the second mobile device in response to the checking operation determining that the predefined condition is met, wherein the information comprises the presence of the particular traffic situation relative to the first mobile device.

The current location data or movement information of the first mobile device comprises, in particular, the current location of the first mobile device and optionally also further information relating to a movement of the first mobile device, for example a direction of movement, a speed, an acceleration or a path prediction of the first mobile device or of a vehicle connected to said mobile device. For example, the first mobile device is a mobile telecommunications terminal, in particular a smartphone, an electric bicycle control device, or a component of a driving assist system. Preferably, current location data and movement information of the first mobile device is transmitted to the server.

The current location data or movement information is transmitted from the first mobile device to the server only when the mobile device is in the monitoring area defined for the first mobile device. The monitoring area is an area in reality bounded, for example, by a so-called geofence. Thus, the first mobile device preferably does not always transmit the location data or movement information to the server, but only when said first mobile device is present in the monitoring area. However, it is noted that the monitoring area may be defined to move along with the first mobile device. In that case, the first mobile device is continuously present in the monitoring area and the location data or movement information is preferably continuously transmitted until the monitoring area is redefined. Capturing the current location of the first mobile device is typically done by means of a positioning system, preferably a satellite-based positioning system.

The transmission of the location data or movement information by the first mobile device to the server is preferably done by means of a radio connection, for example via a Wi-Fi connection or a cellular connection. Thus, if the first mobile device is present in the monitoring area, location data or movement information regarding the first mobile device is available to the server and it is known to the server where the first mobile device is located and/or how said device is moving within the monitoring area. This is because the location data or movement information is transmitted as long as the first mobile device is present in the monitoring area, and the continuous transmission of the location data may also be suspended as long as the first mobile device is present on the predicted and also communicated path defined, for example, by the movement information. The server checks whether a user relevant interaction of the first mobile device with a further mobile device, in this case a second mobile device, takes place. This is the case, for example, if the movements of the first mobile device and the second mobile device indicate that a collision could occur between the mobile devices or the vehicles or persons transporting said mobile devices. To this end, location data of the second mobile device is also transmitted to the server. Preferably, the current location data of the second mobile device is transmitted to the server only if the second mobile device is also present in the same monitoring area as the first mobile device. Optionally, the current location data of the second mobile device is transmitted to the server only if the second mobile device is in a dedicated monitoring area defined for the second mobile device. In that case, the location data of the two mobile devices are related to each other via the predefined condition when the monitoring areas associated with the mobile devices overlap.

The server checks whether a predefined condition exists, wherein the predefined condition defines a dependency between the current location data of the first mobile device and current location data of the second device. The condition may also include further information, such as, for example, information regarding visual obstructions. A position and/or movement of the two mobile devices in the real world is thus considered and said devices are placed in relation to each other. If said location data, i.e. the positions and movements of the mobile devices in the real world meet a certain predefined condition, then this indicates particular associated traffic situations. For example, based on the current locations of the mobile devices, it may be detected whether said devices are approaching each other and a collision is imminent. In the present example, the pending collision is the traffic situation caused by the second device. Based on the predefined condition and optional further predefined conditions, different traffic situations may be defined and detected by the server.

Information is transmitted by the server to the first and/or the second mobile device in response to the checking operation determining that the predefined condition is met, that is, there is a traffic situation of interest to a user of the first and/or second mobile device, respectively. If necessary, an indication may be output to a user by the first or second mobile device, respectively, wherein said output of indications to the user may be linked to further conditions.

Thus, a mutually intelligent presence alert may also be created by road users via mobile communications or other wireless communications provided in certain geographically limited regions. One geographically limited region is the monitoring area. Because in particular vulnerable road users typically do not carry dedicated devices that would make them visible in radio traffic between vehicles (V2X), but very likely do carry mobile devices, such as smartphones, the present approach can be used in particular to protect vulnerable road users such as pedestrians and cyclists. For example, cyclists and/or motorists may be warned when both are both in the area of an accident hot spot, such as an intersection, a roundabout, an exit, etc., having statistically significant frequent collisions.

It is noted that preferably, both the first mobile device and the second mobile device are a cellular device. Alternatively, the first mobile device is preferably a cellular device and the second mobile device is a V2X-enabled device that also provides information to the server, for example via V2X-enabled infrastructure

Thus, a method is produced by means of which road users can be intelligently informed of the presence or the approaching of other road users. In this respect, the method very efficiently handles the volume of data to be transmitted, the computing capacities on the participating servers, and the privacy of the participants, for example, in that the location data or movement information is captured and transmitted to the server only at particular accident focal points.

Optionally, the captured location data or movement information is also used in anonymized form for traffic counts to be performed for the monitoring area. An accident recorder can thus also be produced in that the location data or movement information is temporarily stored by the server and provided if a collision subsequently occurs.

The dependent claims show preferred refinements of the invention.

Preferably, the defining of the monitoring area is accomplished by transmitting a definition of the monitoring area from the server to the first mobile device. Thus, so-called dynamic monitoring areas are created and communicated to the first mobile device by the server. It can thereby be variably or dynamically defined where the monitoring area is located. For example, the server defines such monitoring areas where an accident has currently occurred. Such areas result in increased risk of further collisions, and thus it is advantageous for location data or movement information to be provided for such an area by the first mobile device in order to obtain information about other road users, here of the second device, and also to provide location data or movement information by which other road users may be informed of the movement of the first mobile device. Optionally, monitoring areas may be configured by a user of the first mobile device, for example via an online platform connected to the server. For example, a monitoring area may be configured by the user of the first mobile device to cover a particular path, for example, a path programmed in a navigation device. Further, optionally, a movable monitoring area moving with the first mobile device may be booked by the user of the first mobile device. In that case, preferably, current location data is continuously transmitted from the first mobile device. However, only such further devices that are also present in said movable monitoring area are checked by the server in combination with the first mobile device with respect to the predefined condition. A computational effort of the server is thus kept to a minimum.

Preferably, the monitoring area is dependent on the current location of the first mobile device or the current location of the second mobile device. This is the case when the monitoring area is moved together with the first mobile device. The monitoring area may optionally be configured to a particular dimension, for example as a square segment around the first mobile device, having a dimension of ±10 arc seconds, i.e. a dimension of approximately 200 m in Germany, for example.

Preferably, the defining of the monitoring area is also carried out for the second mobile device, in particular also capturing an associated current location of the second mobile device and transmitting location data by the second mobile device to the server in response to the current location of the second mobile device being within the monitoring area.

Preferably, a detecting of a sensor signal of a sensor of the first mobile device or of a connected device takes place, wherein the transmitting of the current location data of the first mobile device to the server is dependent on the sensor signal, and/or the predefined condition also defines a dependence on the sensor signal and/or other information obtained, and/or outputting an indication to a user of the first mobile device in response to receiving the information is dependent on the sensor signal. For example, the sensor senses a present brightness in the area of the first mobile device or senses a temperature in the area of the first mobile device. If said information captured as sensor data indicates, for example, poor visibility or poor road conditions, then the current location data is transmitted. Otherwise, the current location data is not transmitted even when the first mobile device is in the monitoring area. Analysis of road conditions could also be performed by means of a camera of the first mobile device and the current location data could be provided for poor road conditions. For example, the connected device is a vehicle sensor. Alternatively or additionally, in this way it can be decided whether information is sent to the first mobile device according to the predefined condition. For example, a distance for an approach alert could be assessed differently by the server depending on a temperature indicated by the sensor, and thus, for example, depending on a weather situation. Also, for example, the decision to finally initiate an approach alert may be made locally by the first mobile device based on the sensor data.

It is also advantageous if the transmitting of the current location data of the first mobile device to the server is dependent on an ambient condition of the first mobile device and/or the predefined condition also defines a dependence on an ambient condition of the first mobile device and/or outputting an indication to a user of the first mobile device in response to receiving the information is dependent on the ambient condition. The ambient condition of the first mobile device may be obtained from any source of information. The ambient condition may also be detected by the sensor of the first mobile device, among other things. Alternatively, the ambient conditions are preferably obtained depending on the position, for example by retrieving weather information, or lighting conditions are determined based on a time of day. Also in the present example, unfavorable light conditions such as rain, poor visibility and poor road conditions, such as ice, snow and wetness, may be deduced. If such unfavorable conditions are present, then the current location data is transmitted within the monitoring area. If said unfavorable conditions are not present, then the location data is not transmitted, even if the first mobile device is present within the monitoring area.

Further, it is advantageous to check, when the server performs the checking operation by means of the predefined condition, whether a distance between the first mobile device and the second mobile device is decreasing and/or whether a visual obstruction is present between the first mobile device and the second mobile device. Thus, by checking the distance, it can be detected whether the mobile devices are approaching each other, which is an indication of a possible impending collision, and thus preferably results in a warning of the users. Visual obstruction between the first mobile device and the second mobile device may also be detected based on the location data, for example, in that visual obstruction objects are stored on the server with the associated position thereof. Based on simple geometric calculations, it can be determined whether such a visual obstruction is disposed between the first and second mobile devices. If this is the case, it can be concluded that the users of the two mobile devices cannot see each other, making a warning by means of the system according to the invention advantageous. The visual obstruction may also be provided by a further mobile device, also providing the location data thereof.

It is also advantageous if, together with the location data, usage information of the mobile devices is also transmitted to the server, indicating the presence of a user behavior of a user of the associated mobile device, and when the checking operation is performed by the server using the predefined condition, a check is made as to whether the user behavior of the second mobile device indicates a user distraction. For example, the second mobile device transmits to the server, as usage information, whether interaction is taking place between the user and the second mobile device. For example, it may be determined whether a touch screen of the second mobile device is being used or a webpage is being presented to a user. Alternatively or additionally, the usage information may also describe whether the second mobile device is currently being used for a call or for reading or writing a text message. If this is the case, said information is transmitted to the server as usage information. The server is thus enabled to take said information into account within the framework of the predefined condition. Optionally, the usage information is also transmitted from the first mobile device to the server, whereby a warning of the user of the second mobile device may take place. Optionally, the usage information is also transmitted from the second mobile device to the server, whereby a warning of the user of the first mobile device may take place.

Alternatively or additionally, based on the usage information, a decision is made by the first mobile device as to whether by the first mobile device outputs an indication for a user of the first mobile device in response to receiving the information. Thus, for the decision in the terminal device, here the first mobile device, whether information obtained from the server is displayed or not can be made depending on the degree or type of distraction of the user.

It is also advantageous if the first mobile device outputs an indication for a user of the first mobile device in response to receiving the information, wherein the indication is in particular output only if a further condition is met, by which a local relevance of the traffic situation is determined. Thus, the presence of a caused traffic situation can also be defined very specifically. For example, information is provided with the presence of the traffic situation that the second mobile device is present in an area to the left and in front of the first mobile device. In this case, for example, it would be advantageous if the indication is provided to the user only if it is evident that the user of the first mobile device is planning a left turn.

### BRIEF DESCRIPTION OF THE DRAWINGS

Embodiment examples of the invention are explained in detail below with reference to the accompanying drawings. The drawing shows:

FIG. 1 a schematic representation of a system for providing location-dependent traffic information;

FIG. 2 a flow diagram of a method according to the invention for providing location-dependent traffic information;

FIG. 3 an exemplary representation of a static monitoring area having a first mobile device present therein;

FIG. 4 an exemplary representation of a movable monitoring area carried with the first mobile device; and

FIG. 5 an exemplary representation of a movable monitoring area carried incrementally with the first mobile device.

### EMBODIMENTS OF THE INVENTION

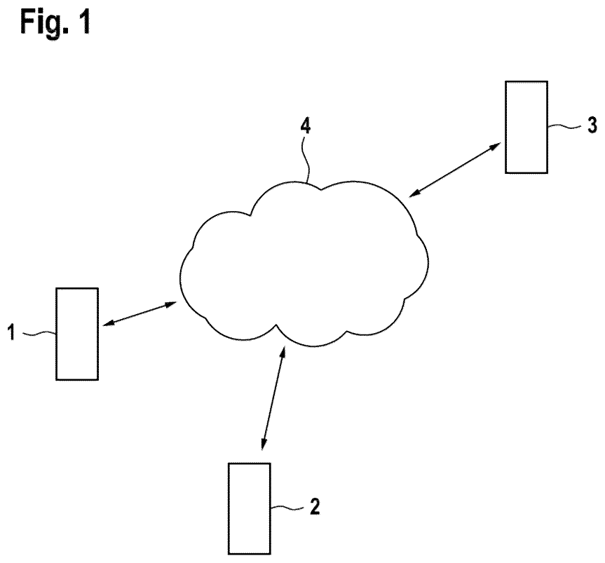

FIG. 1 shows a system for providing location-dependent traffic information. The system comprises a first mobile device 1, a second mobile device 2, and a server 3. The system optionally comprises any arbitrary number of mobile devices, and the server 3 is not necessarily a single computing unit, but may consist of a combination of a plurality of computing systems.

Mobile devices 1, 2 are mobile telephones, for example, in particular smartphones. Alternatively, the first mobile devices are components of driving assistance systems or control units of electric bicycles or components of cycling computers. Mobile devices 1, 2 may be different types of devices. The mobile devices 1, 2 are connected to the server 3 via a cellular network 4 for communicating with the same.

It is intended that information about a location or a movement of the second mobile device is provided to a user of the first mobile device 1 when said information is relevant to the user for safety-related reasons, for example. For example, an approach alert is thus provided by the system according to the invention.

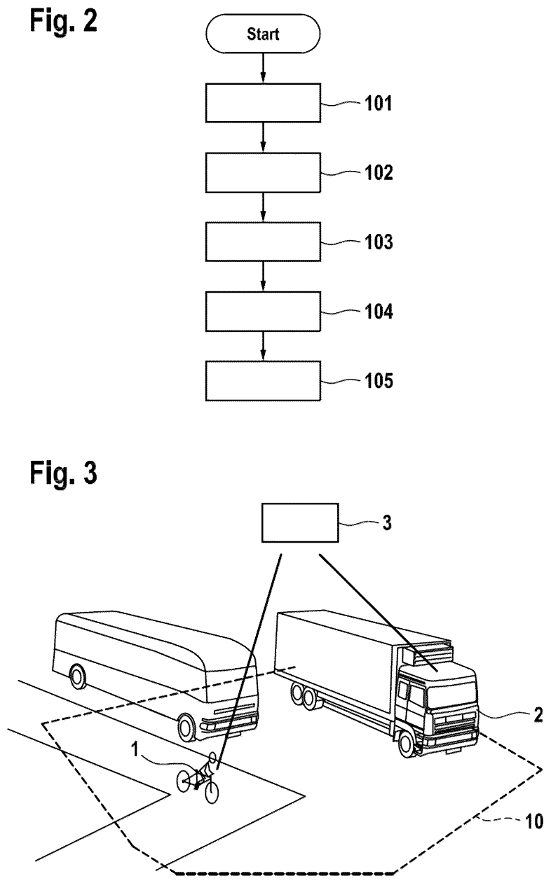

FIG. 2 shows a flow chart of a method according to the invention for providing location-dependent traffic information performed by the system for providing the location-dependent traffic information.

In a first method step 101, a monitoring area 10 for the first device 1 is defined. The monitoring area 10 is an area in the real world describing for example, a geofence. The monitoring area is a localized area known to the first device 1. Defining the monitoring area 10 for the first mobile device 1 can be done in a variety of ways. Thus, either static monitoring areas or dynamic monitoring areas may be defined.

A static monitoring area is a monitoring area stored in the first mobile device 1 and cannot be modified by a user. For example, such static monitoring areas may mark accident focal points, which typically do not change. Exemplary accident focal points are corresponding intersection areas or hazardous sections of a highway. The static monitoring areas are changed as part of a software update, for example.

The dynamic monitoring areas are such monitoring areas defined by the server 3 and transmitted to the first mobile device 1 and the second mobile device 2. Thus, in this case, the monitoring area 10 is implemented by communicating a definition of the monitoring area 10 from the server 3 to the first mobile device 1. The monitoring area 10 may be defined differently on the server side by the server 3. For example, a monitoring area 10 may be selected by a user of the mobile device via a server interface and transmitted from the server 3 to the first mobile device 1. A user of the first mobile device 1 may thereby, for example, book a monitoring area 10, optionally also for payment, covering a route to be traveled, for example. Alternatively, for example, a monitoring area 10 may be booked by the user of the first mobile device 1 and move with the first mobile device 1 and comprise an environment of the first mobile device 1. A dynamically carried monitoring area 10 for the first mobile device 1 can thus also be defined. It is also advantageous if accident positions are detected based on further traffic information provided to the server 3 and monitoring areas 10 are defined for said accident positions and transmitted to the first mobile device 1.

In a second method step 102 of method 100, an associated current location of the first mobile device 1 is continuously determined by the first mobile device 1. This is done in a second method step 102 of method 100 carried out continuously in a loop, however, also in parallel with the further method steps.

In a third method step 103, location data and/or movement information is transmitted by the first mobile device 1 on the server 3 in response to the current location being within the monitoring area 10. The first mobile device 1 thus detects whether the first mobile device 1 is present within the geofence defined by the monitoring area 10. The location data and/or movement information is transmitted to the server 3 by the first mobile device only if said device is present within the monitoring area 10. Optionally, a plurality of monitoring areas 10 may also be defined for the first mobile device 1 and the location data and/or movement information transmitted by said device when said device is present within one of the monitoring areas. If the first mobile device 1 is not present within the monitoring area 10, no location data and/or movement information is transmitted. It is thus achieved that at such positions where the location data is supposed to be less relevant, said data is not transmitted. The location data and/or movement information particularly includes the continuously updated location of the first mobile device 1, and optionally also additional information regarding a speed or direction of movement of the first mobile device 1. The movement information particularly includes a trajectory along which the mobile device 1 is expected to move. In particular, by transmitting such a trajectory, it is achieved that information does not need to be transmitted continuously. The server 3 is thus aware of a current position of the first mobile device 1 and, over a period of time, also of a movement of the first mobile device 1 whenever said device is present within the monitoring area 10.

In addition, reference is made only to the location data. It is noted, however, that instead of the location data, the movement information may also be used in a corresponding manner or said information may be used in addition to the location data.

Optionally, the location data from the first mobile device 1 is transmitted to the server 3 only if another condition is met. For example, the current location data is transmitted by the first mobile device 1 to the server 3 depending on a sensor signal of a sensor of the first mobile device 1 and/or depending on an ambient condition of the first mobile device 1. For example, the nature of the ambient conditions of the first mobile device 1 is determined by a sensor of the mobile device 1 or by other information, such as a time of day or weather information available online. Current light conditions, such as light/dark, a present weather condition, such as rain, a prevailing visibility, or prevailing road conditions are determined, for example. For example, the current location data of the first mobile device 1 is transmitted to the server 3 only if unfavorable ambient conditions are present, as is the case in low light conditions, unfavorable weather conditions, poor visibility, or poor road conditions. Such conditions generally increase a risk of collisions, and thus transmission of current location data within the monitoring area 10 may be more relevant. Monitoring areas 10 may thus be defined, for example, which form an accident focal point only in unfavorable weather or visibility conditions.

In a fourth method step 104, a checking operation is performed by the server 3. In so doing, it is checked for the first mobile device 1 whether a predefined condition is met. The predefined condition here defines a dependence between the current location data of the first mobile device 1 and current location data of the second mobile device 2. The functionality of the second mobile device 2 corresponds to the first mobile device 1 and provides the location data thereof in a corresponding manner when said device is present within the monitoring area 10. For example, current location data is provided by both mobile devices 1, 2 when both are within a monitoring area 10 defined by an accident focal point. A relationship of the positions and movements of the two mobile devices 1, 2 to each other is checked by the predefined condition. Such a ratio indicates particular traffic situations caused by the second mobile device 2 from the perspective of the first mobile device 1. If, for example, an approach alert is to be provided, then the predefined condition is used to check whether a distance between the first mobile device 1 and the second mobile device 2 is decreasing. Such a decrease in distance, particularly a decrease below a threshold, indicates that there may be a future collision between the vehicles with which the first mobile device 1 and the second mobile device 2 are traveling.

Alternatively or additionally, the predefined condition checks whether there is a visual obstruction between the first mobile device 1 and the second mobile device 2, for example, due to an object disposed there, by which a line of sight between the two devices 1, 2 is interrupted.

The predefined condition may be chosen arbitrarily to define and detect particular present traffic situations involving the first and second mobile devices 1, 2. The predefined condition is not necessarily a single condition, but may also be formed by a chain of conditions. For example, it may be checked whether the two mobile devices 1, 2 are approaching each other and at the same time whether the distance has already dropped below a minimum distance. The combination of said two checking steps may also be considered a predefined condition.

Alternatively or additionally, a present user behavior of a user of the second mobile device 2 is also checked as part of the predefined condition. Preferably, usage information of the mobile devices 1, 2 is also transmitted to the server 3 with the location data. The usage information is indicative of a present user behavior of a user of the associated mobile device 1, 2. For example, the usage information indicates whether there is interaction between the respective mobile device 1, 2 and the associated user. This is detected, for example, in that an interaction with a touch screen is taking place, messages being written, a call being made, or particular software being open. Said information is provided to the server 3. As part of the checking operation, it is checked whether the attention of the user of the second mobile device 2 may be limited according to the usage information. If this is the case, the traffic situations detected in the context of the checking operation may be considered more critically, for example by tightening the predefined conditions or by the presence of a caused traffic situation only based on the usage information.

Alternatively or additionally, in the context of the predefined condition, an ambient condition of the first mobile device is also considered, for example a current weather, a presence of an obstruction to vision (from map or dynamic), or present visibility conditions (bright/dark, etc.). Said information is provided to the server either by one of the mobile devices 1, 2 present in the monitoring area 10 or by an external source. Depending on said further conditions, it can be detected whether a particular traffic situation exists.

If a particular traffic situation has been detected by the server 3 as part of the checking operation, because the predefined condition is met, information is transmitted to the first mobile device 1 by the server 3 in a fifth method step 105. The information describes the presence of the particular traffic situation with respect to the second device 2. For example, the first mobile device 1 is provided with the information that the second mobile device 2 is approaching and could lead to a collision. Also, the information could be provided to the first mobile device 1 that the second device 2 is approaching and that the user thereof has reduced attention. The information transmitted to the first mobile device 1 may be provided to the user of the first mobile device 1 in any manner, for example by a graphic indicator or by an acoustic alert. Depending on how specifically the predefined condition and the associated caused traffic situation is defined, very specific warning indications can also be given, for example, that the second mobile device 2 is approaching from the front right.

It is noted that the first mobile device 1 and the second mobile device 2 preferably operate on the same operating principles and are preferably also identical in construction or perform the same method according to the invention. It is thereby achieved that both the first mobile device 1 can be informed about the second mobile device 2 and the second mobile device can receive information about the first mobile device 1. Accordingly, it is advantageous for location data and usage information to be provided by both mobile devices 1, 2.

It is also advantageous for further mobile devices to communicate with the server 3, but said devices are not bound by the previously described data exchange, and rather do not provide associated location data, for example, but receive information regarding the movement of the first mobile device 1 or the second mobile device 2.

Further, it is advantageous for communication to occur between the first mobile device 1 and a vehicle in or on which the first mobile device 1 is disposed. Additional movement information of the vehicle can thereby be captured by the first mobile device 1, for example, and information of vehicle sensory systems such as a steering wheel angle or an activation of a turn signal can be detected. In this case, it is advantageous to use said information to determine whether information provided by the server 3 has local relevance to the first mobile device 1. For example, the first mobile device 1 may detect that the vehicle in which the first mobile device 1 is located is turning left, while the server 3 provides the information that another vehicle is located to the right in front of the first mobile device 1. In that case, the first mobile device 1 may locally decide that, despite the present approach, there is no risk of collision, as said risk is averted by the indicated turning process. It is therefore advantageous if an indication is output by the first mobile device 1 only if a further condition is met, by which a local relevance of the traffic situation is determined.

FIG. 3 shows a first exemplary scenario in which a monitoring area 10 is defined at an accident focal point in the area of a T-junction. The first mobile device 1 is carried by a driver of a bicycle. Because the first mobile device 1 is present within the monitoring area 10, location data is provided from the first mobile device 1. Said device is thus visible to other users of the system. The second mobile device 2 1 is carried by a driver of a truck. As the second mobile device 2 is also within the monitoring area 10, current location data is also provided from said device to the server 3. The server 3 detects that the two mobile devices 1, 2 are approaching each other. By selecting the predefined conditions on the server 3 accordingly, information is transmitted to both mobile devices 1, 2, by which the associated users are informed about the approaching of the vehicles thereof. In particular, the second mobile device 2 indicates that a bicycle, i.e. the first mobile device 1, is present in a planned trajectory of the truck. This is particularly precisely detected when information regarding a steering angle of the truck is also provided to the second mobile device 2.

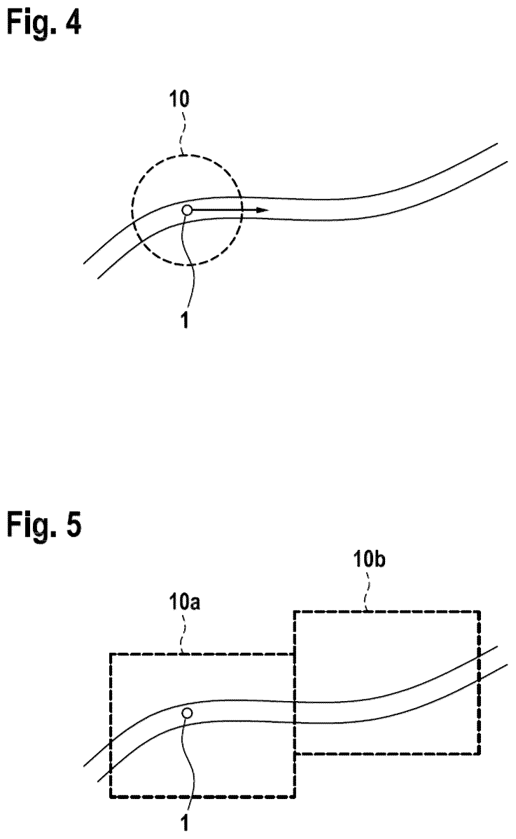

FIG. 4 shows an exemplary scenario for a monitoring area 10 carried along with the first mobile device 1. For example, the monitoring area 10 is defined to cover a space of a radius of 100 m around the first mobile device 1. Current location data is thus continuously transmitted to the server 3 by the first mobile device 1. However, the method is nevertheless advantageous because only the current location data from other mobile devices 1 also present within the monitoring area 10 is compared by the server 3 with the current location data of the first mobile device 1 by means of the predefined conditions. In the situation shown in FIG. 4, no further mobile device is present in the monitoring area 10. Thus, while location data is transmitted from the first mobile device 1 to the server 3, said server merely checks the current location of the monitoring area 10 by means of the location data and whether another mobile device is present in said monitoring area 10. The further checking of the predefined condition does not take place until another mobile device is present within the monitoring area 10, the position of which is defined by the first mobile device 1. To this end, the further devices, for example the second device 2, are informed of the current location of the monitoring area 10 defined by the first mobile device. Said monitoring area of the first mobile device 1 is then also considered a monitoring area by the second mobile device 2. Thus, location data is transmitted from both mobile devices 1, 2 to the server 3 and a decision about the presence of a traffic situation can be made by the same.

FIG. 5 shows an alternative implementation for a movable monitoring area 10. The monitoring area 10 is not continuously carried along, but rather a route to be traveled is divided into individual sections, whereby each of the sections is associated with a monitoring area. Thus, the path to be traveled shown in FIG. 5 is divided into a first monitoring area 10a and a second monitoring area 10b. The first monitoring area 10a is active as long as the first mobile device 1 is present within the first monitoring area 10a. When the first mobile device 1 moves across the boundary between the first monitoring area 10a and the second monitoring area 10b, the first monitoring area 10a becomes inactive and the second monitoring area 10b becomes active as the monitoring area for the first mobile device 1.

The system according to the invention thus creates a (mutual) intelligent presence alert/information of road users by means of mobile communications in particular geographically limited areas.

Because vulnerable road users (VRUs) typically do not carry dedicated devices that would make said users visible in radio traffic between vehicles (V2X), but very well do carry mobile phones (smartphones), the present approach is particularly able to protect VRUs.

For example, cyclists and/or motorists may be warned when both are currently in the area of an accident hot spot (e.g., intersection, roundabout, exit, etc., having a statistically significant cluster of collisions).

By means of the invention, a method is proposed by means of which the presence or the approach of other road users can be intelligently pointed out to road users (particularly VRUs). The procedure is very efficient in terms of the volume of data to be transferred, the computing capacities on the servers involved, and the privacy of the participants, for example, by collecting said data only in particular accident focal points (geofences).

As a by-product, the collected data may, of course, also be used in anonymized form for traffic counting (number and times of passage through of the geofences, speeds, etc.). Another by-product is an accident recorder for capturing the movement data immediately prior to a collision if such takes place.

The core of the invention is that effective and lean protection of road users from collisions is achieved by ensuring that road users only send movement data thereof via cellular communications to the server 3, in particular an application server, when particular conditions are met, and that the application server can generate a mutual presence or approach alert/information and send the same to the affected participants when further conditions are met.

In addition, from a technical point of view, said data may also be used for further purposes, such as a traffic counting record in the geofences or an accident recorder of the movement data prior to an accident.

Conditions for road users to send location and other data (such as VRU type, see e.g. contents of ETSI VAM) are, according to the invention, the presence in/travel through a particular locally delineated area (Geofence), optionally combined with other criteria. Said areas are referred to as the monitoring area.

Monitoring areas may be (Quasi)static geofences (updated only occasionally, e.g. together with a software update). This includes, for example, (potential) accident focal points, e.g., a corresponding intersection area or a hazardous section on a highway.

Monitoring regions may be dynamic geofences updated cyclically (e.g., every 1-30 seconds). For example, a cyclist (optionally for a fee) can book visibility along a route (e.g., navigation route), optionally in sections (depending on the present location). Also, for example, a cyclist may book a radius or a particular square segment of +-10 arc seconds (˜200 m in Germany) around said cyclist (dynamically carried) or the monitoring area is defined e.g. around a location (on a road) where an accident has just occurred (via HelpConnect).

It is also contemplated to initially activate geofences, i.e. monitoring domains, only for VRUs (based on the assumption that VRUs may be more willing to share location data in order to be protected) and only activate said geofences for cars or other “dangerous” road users if a VRU is present in said fence. This condition is combinable with all the others mentioned.

Further information may also be used as additional conditions, in particular such information that is easily determined offline by the road user by means of corresponding sensors, such as light conditions (light, dark), rain, poor visibility, or poor road conditions (e.g. ice, snow, wetness).

Conditions for presence alerts/information being sent from the server 3 to the road users may be selected as follows:
a plurality of road users are in the same monitoring area and are moving such that the distance decreases,
visual obstructions, which may also be stored in the monitoring area, indicate that the road users do not see each other, and/or
available information indicates that a road user is distracted (e.g., looking at a cell phone or listening to music) (said information may be communicated in part via the ETSI VAM formats).

Conditions for when and how the information provided by the server 3 may be displayed to the road user may be selected as follows:
a potentially turning driver does not receive an alert until the steering wheel is turned/the turn signal is set, and/or
a driver on a highway will only receive information about the cyclist in front if it is clear that the distance has fallen below a particular distance.

Also, some of the aforementioned conditions may be combined with each other, which would mean that a transmission is made somewhat more often, but, for example, a warning is still only issued in case of darkness or at an increased speed.

In addition to the written disclosure hereinabove, we make explicit reference to the disclosure of FIGS. 1 through 5.

1. A method for providing location-dependent traffic information, comprising:
defining a monitoring area for a first mobile device;
capturing an associated current location of the first mobile device;
transmitting location data or movement information by the first mobile device to a server in response to the current location being within the monitoring area;
performing a checking operation by the server,
wherein the first mobile device is checked as to whether a condition is met,
wherein the predefined condition defines a dependence between the current location data or movement information of the first mobile device and current location data or movement information of a second mobile device also present within the monitoring area, and
wherein the predefined condition indicates a traffic situation caused by the second mobile device; and
transmitting information by the server to the first mobile device in response to determining, in the checking operation, that the predefined condition is met, the information including the presence of the determined traffic situation relative to the second device.

2. The method according to claim 1, wherein the defining of the monitoring area is carried out by transmitting a definition of the monitoring area from the server to the first mobile device and wherein the monitoring area is an area defined by the second mobile device.

3. The method according to claim 1, wherein the monitoring area is dependent on the current location of the first mobile device or dependent on the current location of the second mobile device.

4. The method according to claim 1, further comprising:
defining the monitoring area for the second mobile device,
capturing, by the second mobile device, an associated current location of the second mobile device, and
transmitting, by the second mobile device, location data or movement information to the server in response to the current location of the second mobile device being within the monitoring area.

5. The method according to claim 1, wherein a sensor signal of a sensor of the first mobile device or a connected device is captured, and wherein:
the current location data or movement information of the first mobile device is transmitted to the server depending on the sensor signal, and/or
the predefined condition also defines a dependence on the sensor signal, and/or
an indication to a user of the first mobile device is output in response to receiving the information depending on the sensor signal.

6. The method according to claim 1, wherein:
the current location data or movement information of the first mobile device is transmitted to the server depending on an ambient condition of the first mobile device, and/or
the predefined condition also defines a dependence on an ambient condition of the first mobile device, and/or
an indication for a user of the first mobile device is output in response to receiving the information depending on the ambient condition.

7. The method according to claim 1, wherein when the server performs the checking operation by way of the predefined condition, it is checked whether a distance between the first mobile device and the second mobile device is decreasing and/or whether a visual obstruction is present between the first mobile device and the second mobile device and/or further conditions are met.

8. The method according to claim 1,
wherein, along with the location data or movement information, usage information of the mobile devices is also transmitted to the server and indicates a present user behavior of a user of the associated mobile device, and
wherein, when the server performs the checking operation, the predefined condition is checked as to whether the user behavior of the user of the second mobile device indicates a user distraction, and/or
wherein, based on usage information of the first mobile device a decision is made by the first mobile device as to whether an indication is output by the first mobile device in response to receiving the information for a user of the first mobile device.

9. The method according to claim 1,
wherein the first mobile device outputs an indication for a user of the first mobile device in response to receiving the information, and wherein the indication is output only if a further condition is met, by which a local relevance of the traffic situation is determined.

10. A mobile device for providing location-dependent traffic information, the mobile device being configured to:
capture a definition of a monitoring area;
capture a current location of the mobile device;
transmit current location data or movement information of the mobile device to a server in response to the current location of the mobile device being within the monitoring area; and
receive information from the server wherein the information indicates the presence of a particular traffic situation with respect to a second device.

11. A server for providing location-dependent traffic information, the server being configured to:
receive current location data or movement information from mobile devices present within a monitoring area according to the current location thereof;
perform a checking operation,
wherein, for at least a first device of the mobile devices present within the monitoring area it is checked whether a predefined condition is met,
wherein the predefined condition defines a dependence between the current location data or movement information of the first mobile device and the current location data or movement information of at least one second device of the mobile devices also located within the monitoring area, and
wherein the predefined condition indicates a traffic situation caused by the second device and
transmit to the first mobile device the information indicating the presence of the particular traffic situation with respect to the second device in response to determining, in the checking operation, that the condition is met.
